(19) United States
(12) Patent Application Publication
(10) Pub. No.: US 2022/0156445 A1
(43) Pub. Date: May 19, 2022

(54) METHOD AND APPARATUS FOR PREDICTING POWER CONSUMPTION OF AN INTEGRATED CIRCUIT BY ADJUSTING OPERATING VOLTAGE AND TEMPERATURE CORNER

(71) Applicant: Baum Design Systems Co., Ltd., Seoul (KR)

(72) Inventor: In Hak HAN, Daejeon (KR)

(21) Appl. No.: 17/471,175

(22) Filed: Sep. 10, 2021

(30) Foreign Application Priority Data
Nov. 19, 2020 (KR) 10-2020-0156006

(51) Int. Cl. G06F 30/36

(52) U.S. Cl. CPC G06F 30/36; G06F 2119/06

(57) ABSTRACT

The present disclosure relates to a method of predicting power consumption of an integrated circuit. The method includes receiving a gate-level netlist of the integrated circuit, receiving a plurality of libraries defining operation of at least one cell included in the netlist, receiving signal switching information in the netlist, receiving a target corner including a target operating voltage (VDD_{targ}) and a target temperature (T_{targ}), and estimating switching power at the target corner of the integrated circuit on the basis of the netlist, the signal switching information, and the target operating voltage (VDD_{targ}).

### CROSS-REFERENCE TO RELATED APPLICATION

This application claims priority to and the benefit of Korean Patent Application No. 10-2020-0156006, filed on Nov. 19, 2020, in the Korean Intellectual Property Office, the disclosure of which is incorporated herein by reference in its entirety.

### BACKGROUND

### 1. Field of the Invention

The present disclosure relates to a method and apparatus for predicting power consumption of an integrated circuit while adjusting an operating voltage and a temperature corner for predicting power consumption at a target corner.

### 2. Discussion of Related Art

It is important to predict power consumption of integrated circuits used in various technical fields. However, since the power consumption of integrated circuits is greatly affected by the operating voltage and temperature, it is necessary to create technology libraries in a wide variety of corners (operating voltage and temperature) in order to accurately predict power consumption for various designs and scenarios.

However, it also takes a long time to generate even one library because the technology libraries include information on functions, timing, and power consumption of all cells included in a gate-level netlist and are generated using transistor-level simulation. Therefore, it is practically difficult to generate libraries in various corners in advance.

### SUMMARY OF THE INVENTION

The present disclosure provides a method, apparatus, and computer program for predicting power consumption of an integrated circuit while adjusting an operating voltage and a temperature corner, and the computer program is stored in a recording medium.

The present disclosure may be implemented in various ways including a method or a computer program stored in a readable storage medium.

According to an aspect of the present disclosure, there is provided a method of predicting power consumption of an integrated circuit, which is performed by at least one processor, the method including receiving a gate-level netlist of the integrated circuit, receiving a plurality of libraries defining operation of at least one cell included in the netlist, receiving signal switching information in the netlist, receiving a target corner including a target operating voltage (VDD_{targ}) and a target temperature (T_{targ}), and estimating switching power at the target corner of the integrated circuit on the basis of the netlist, the signal switching information, and the target operating voltage (VDD_{targ}).

The method may include estimating internal power at the target corner of the integrated circuit on the basis of internal power data included in a library for a first corner among the plurality of libraries, the signal switching information, and the target operating voltage (VDD_{targ}).

The method may include estimating the leakage power at the target corner of the integrated circuit on the basis of leakage power data included in the library for the first corner, leakage power data included in a library for a second corner, leakage power data included in a library for a third corner, the signal switching information, the target operating voltage (VDD_{targ}), and the target temperature (T_{targ}). The first corner comprises a first corner operating voltage (VDD₁) and a first corner temperature (T₁), the second corner comprises a second corner operating voltage (VDD₂) and a second corner temperature (T₂), and the third corner comprises a third corner operating voltage (VDD₃) and a third corner temperature (T₃). The second corner operating voltage (VDD₂) and the third corner operating voltage (VDD₃) are different from each other, the second corner temperature (T₂) and the third corner temperature (T₃) are different from each other, the first corner and the second corner are different from each other, and the first corner and the third corner are different from each other.

The method may further include outputting average power consumption or power waves of the integrated circuit on the basis of the estimated switching power, internal power, and leakage power at the target corner.

The switching power may represent power consumed while capacitances of all wires in the netlist are charged and discharged, and the switching power at the target corner is calculated to be independent of the target temperature (T_{targ}) and to be proportional to the square of the target operating voltage (VDD_{targ}).

The switching power at the target corner may be calculated as Σ_{i∈NET}aᵢCᵢVDD_{targ}². Here, NET depicts a set of all wires in the netlist, depicts a wire switching activity, and c depicts a wire capacitance.

The first corner may include a first corner operating voltage (VDD₁) and a first corner temperature (T₁), the internal power may represent the sum of the short-circuit power and power consumed by charging and discharging capacitors inside cells included in the netlist, and the internal power at the target corner may be computed to be independent of the target temperature (T_{targ}) and to be proportional to

$${( \frac{{VDD}_{Targ}}{{VDD}_{1}} )}^{2} .$$

The first corner may include a first corner operating voltage (VDD₁) and a first corner temperature (T₁). The estimating of internal power at the target corner of the integrated circuit on the basis of internal power included in a library for a first corner among the plurality of libraries, the signal switching information, and the target operating voltage (VDD_{targ}) may include multiplying power values in internal power data included in the library for the first corner by

$${( \frac{{VDD}_{Targ}}{{VDD}_{1}} )}^{2} .$$

The leakage power of each cell included in the netlist at the target corner is calculated as

$$P ( {VDD}_{1} , {T}_{1} ) \times {T}_{targ}^{2} \times exp ( \frac{α \times {VDD}_{targ} + β}{{T}_{targ}} ) \times \frac{{VDD}_{targ}}{{VDD}_{1}} ,$$

where P(VDD₁,T₁) depicts leakage power at the first corner determined based on leakage power data included in the library for the first corner, α and β are determined by a system of two first order equations:

$$α \times {VDD}_{2} + β = {T}_{2} \times ln ( \frac{P ( {VDD}_{2} , {T}_{2} ) \times {VDD}_{1} )}{P ( {VDD}_{1} , {T}_{1} ) \times {T}_{2}^{2} \times {VDD}_{2} )} ) and$$

$$α \times {VDD}_{3} + β = {T}_{3} \times ln ( \frac{P ( {VDD}_{3} , {T}_{3} ) \times {VDD}_{1} )}{P ( {VDD}_{1} , {T}_{1} ) \times {T}_{3}^{2} \times {VDD}_{3} )} )$$

for each state of each cell included in the netlist. P(VDD₂,T₂) depicts leakage power at the second corner determined by leakage power data included in the library for the second corner, and P(VDD₃,T₃)depicts leakage power at the third corner determined by leakage power data included in the library for the third corner. The leakage power at the target corner is calculated based on the signal switching information, α and β of each cell included in the netlist, the target temperature (T_{targ}), and the target operating voltage (VDD_{targ}).

According to another aspect of the present disclosure, there is provided a computer program stored in a computer-readable recording medium for a computer to execute the above method.

According to another aspect of the present disclosure, there is provided an apparatus including a memory and at least one processor connected to the memory and configured to execute at least one computer-readable program included in the memory. The at least one program comprises instructions configured to receive a gate-level netlist of an integrated circuit, receive a plurality of libraries defining operation of at least one cell included in the netlist, receive signal switching information for the netlist, receive a target corner including a target operating voltage (VDD_{targ}) and a target temperature (T_{targ},), and estimate switching power at the target corner of the integrated circuit on the basis of the netlist, the signal switching information, and the target operating voltage (VDD_{targ}).

### BRIEF DESCRIPTION OF THE DRAWINGS

Embodiments of the present disclosure will be described with reference to the accompanying drawings described below, wherein like reference numerals refer to, but are not limited to, like elements:

FIG. 1 is a diagram illustrating an example in which a power consumption estimation tool generates a power report according to an embodiment of the present disclosure;

FIG. 2 is a schematic diagram illustrating a configuration in which an information processing system is communicably connected to a plurality of user terminals in order to predict power consumption of an integrated circuit according to an embodiment of the present disclosure;

FIG. 3 is a block diagram showing the internal configuration of an information processing system according to an embodiment of the present disclosure;

FIG. 4 is a diagram illustrating an example in which a library converter generates a VDD/temperature dependent library according to an embodiment of the present disclosure;

FIG. 5 is a diagram illustrating an example of a gate-level netlist of an integrated circuit according to an embodiment of the present disclosure;

FIG. 6 is a diagram illustrating an example of calculating internal power data at a target corner by using internal power data at a first corner according to an embodiment of the present disclosure;

FIG. 7 is a diagram illustrating an example of a VDD/temperature dependent library for calculating leakage power at a target corner according to an embodiment of the present disclosure;

FIG. 8 is a flowchart illustrating a method of predicting power consumption of an integrated circuit at a target corner according to an embodiment of the present disclosure;

FIG. 9 is a flowchart illustrating a method of outputting expected power consumption of an integrated circuit at a target corner according to an embodiment of the present disclosure; and

FIG. 10 is a flowchart illustrating a method of generating a VDD/temperature dependent library according to an embodiment of the present disclosure.

### DETAILED DESCRIPTION OF EXEMPLARY EMBODIMENTS

Hereinafter, detailed contents for the practice of the present disclosure will be described with reference to the accompanying drawings. However, if there is a risk of unnecessarily obscuring the gist of the present disclosure in the following description, detailed descriptions of well-known functions or elements will be omitted.

In the accompanying drawings, identical or corresponding components are denoted by the same reference numerals. Furthermore, in the following description of embodiments, repeated descriptions of the same or corresponding components may be omitted. However, even if a component is not described, it is not intended that the component is not included in any embodiment.

Terms used herein will be briefly described, and then exemplary embodiments will be described in detail below. The terms used herein have been selected as general terms which are widely used at present in consideration of the functions of the present disclosure but may be altered according to the intent of an operator skilled in the art, conventional practice, or introduction of new technology. In addition, specific terms have been arbitrarily selected by the applicant and their meanings will be explained in detail in the corresponding description of the present invention. Therefore, the terms used herein should be defined on the basis of the overall content of the present disclosure instead of simply the names of the terms.

Herein, the singular forms “a,” “an,” and “the” include the plural forms unless context clearly indicates otherwise. Also, the plural forms include the singular forms unless context clearly indicates otherwise.

Herein, when one part is referred to as comprising (or including) any element, it should be understood that the part can comprise (or include) other elements rather than excluding other elements unless otherwise stated.

Advantages and features of the disclosed embodiments, and implementation methods thereof will be clarified through following embodiments described with reference to the accompanying drawings. The present disclosure may, however, be embodied in different forms and should not be construed as being limited to the embodiments set forth herein. Rather, these embodiments are provided so that this disclosure will be thorough and complete and will fully convey the scope of the present invention to those skilled in the art.

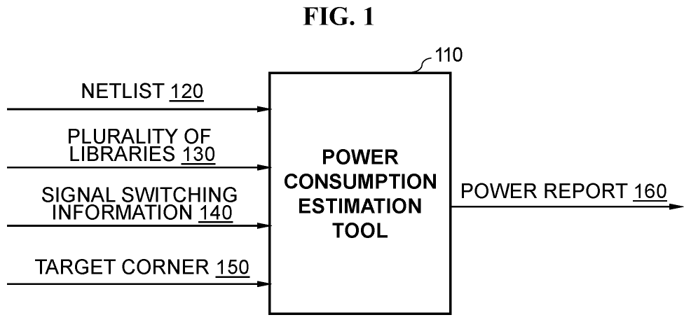

FIG. 1 is a diagram illustrating an example in which a power consumption estimation tool 110 generates a power report 160 according to an embodiment of the present disclosure. The power consumption estimation tool 110 may generate the power report 160 by estimating the power consumption of an integrated circuit in a specific scenario. As shown, the power consumption estimation tool 110 may receive a netlist 120, a plurality of libraries 130, signal switching information 140, a target corner 150, etc. of an integrated circuit, predict power consumption of the corresponding integrated circuit, and generate the power report 160.

In an embodiment, the netlist 120 may be a gate-level netlist of the integrated circuit. That is, the netlist 120 may correspond to a logic circuit configured to perform a logical operation on one or more binary input values to obtain a logical output value. The netlist 120 includes a plurality of cells such as AND, OR, NAND, NOR, NOT, XOR, and XNOR, connection wires between the cells, a pin through which an input value is received, a pin through which an output value is output, etc.

The plurality of libraries 130 may include libraries including information about cells at different corners. Here, a corner may be operating environment information, including operating voltage and temperature, for an integrated circuit. For example, the plurality of libraries 130 may include a library for a first corner, a library for a second corner, a library for a third corner, etc. In this case, the plurality of libraries 130 may include information about cells included in the netlist 120. For example, the plurality of libraries 130 may include the function, timing (in the case of an input value being changed, a delay time until an output value is changed based on the changed input value), power consumption, etc. Here, consumed power may include internal power, leakage power, etc. of a cell at a specific corner.

The signal switching information 140 may include any information (scenario information) associated with the operation/driving of the netlist 120. For example, the signal switching information 140 may be a Fast Signal Data Base (FSDB) file, a Value Change Dump (VCD) file, a Switching Activity Interchange Format (SAIF) file, and the like and may include information on changes in all signals in the netlist 120. Here, the SAIF file may include probability values for changes in signals, and when the SAIF file is used as the signal switching information 140, the power report 160 may include average power consumption. Specifically, the signal switching information 140 may include information such as initial input values of the cells in the netlist 120, changing time of the input values, and input values changing over time. For example, according to the signal switching information 140, the initial input value of pin “A” of an AND gate in the netlist 120 may be determined to be 1, and the input value of pin “A” in 0.1 seconds after the circuit is operated may be determined to be 0.

The power consumption estimation tool 110 may receive the target corner 150 and predict power consumption when an integrated circuit at the target corner 150 is driven according to the signal switching information 140. In this case, the target corner 150 may include target operating voltage VDD_{targ}, target temperature T_{targ}, etc., for predicting power consumption. That is, the power consumption estimation tool 110 may predict the power consumption of the integrated circuit under the input target operating voltage and target temperature.

In an embodiment, the power consumption estimation tool 110 may estimate switching power, internal power, leakage power, etc. at the target corner 150 of the integrated circuit using the netlist 120, the plurality of libraries 130, the signal switching information 140, the target corner 150, etc. Subsequently, the power consumption estimation tool 110 may output the power report 160 including the average consumption power, the power waveform, etc. of the integrated circuit on the basis of the estimated switching power, internal power, leakage power, etc. With such a configuration, even when the plurality of libraries 130 do not include a library for the target corner 150, it is possible for the power consumption estimation tool 110 to effectively estimate or predict switching power, internal power, leakage power, and power consumption of an integrated circuit at the target corner 150 with high accuracy.

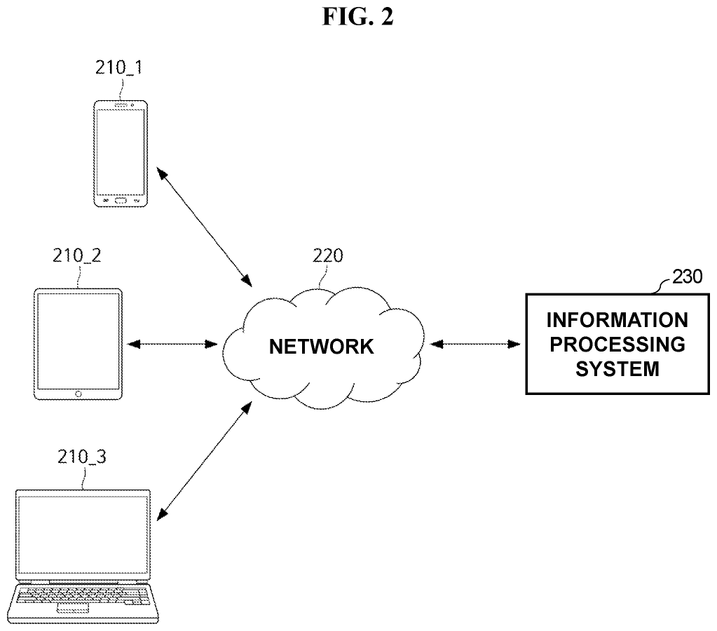

FIG. 2 is a schematic diagram illustrating a configuration in which an information processing system 230 is communicably connected to a plurality of user terminals 210_1, 210_2, and 210_3 in order to predict power consumption of an integrated circuit according to an embodiment of the present disclosure. The information processing system 230 may include an apparatus and system(s) capable of predicting power consumption of an integrated circuit. In an embodiment, the information processing system 230 may include one or more server apparatuses and/or databases capable of storing, providing, and executing computer-executable programs (e.g., downloadable applications) and data related to power consumption prediction of integrated circuits and/or one or more distributed computing apparatuses and/or distributed databases based on cloud computing services. For example, the information processing system 230 may include separate systems (e.g., servers) for predicting power consumption of an integrated circuit.

The power consumption prediction of the integrated circuit provided by the information processing system 230 may be provided to a user through an application for predicting the power consumption of the integrated circuit installed at each of a plurality of user terminals 210_1, 210_2, and 210_3 or the like. Alternatively, the user terminals 210_1, 210_2, and 210_3 may predict the power consumption under the target operating voltage VDD_{targ} and the target temperature T_{targ} using a power consumption prediction program/algorithm of the integrated circuit stored therein. In this case, the user terminals 210_1, 210_2, and 210_3 may directly predict power consumption under the target operating voltage VDD_{targ} and the target temperature T_{targ} without communicating with the information processing system 230.

The plurality of user terminals 210_1, 210_2, and 210_3 may communicate with the information processing system over a network 220. The network 220 may be configured to enable communication between the information processing system 230 and the plurality of user terminals 210_1, 210_2, and 210_3. Depending on the installation environment, the network 220 may include, for example, wired networks such as Ethernet, a wired home network (Power Line Communication), telephone line communication devices, and RS-serial communication, wireless networks such as Wireless LAN (WLAN), Wi-Fi, Bluetooth, and ZigBee, or a combination thereof. The communication scheme may include, but is not limited to, communication schemes which utilize communication networks (e.g., a mobile communication network, a wired Internet network, a wireless Internet network, a broadcasting network, a satellite network, etc.) that may be included by the network 220, as well as short-range communication schemes between user terminals 210_1, 210_2, and 210_3.

Although a mobile phone terminal 210_1, a tablet terminal 210_2, and a PC terminal 210_3 are illustrated as examples of the user terminals in FIG. 2, the present invention is not limited thereto, and the user terminals 210_1, 210_2, and 210_3 may be any computing device capable of wired and/or wireless communication. For example, the user terminals may include a smart phone, a mobile phone, a computer, a notebook, a personal digital assistant (PDA), a portable multimedia player (PMP), a tablet PC, etc. Also, in FIG. 2, three user terminals 210_1, 210_2, and 210_3 are illustrated as communicating with the information processing system 230 over the network 220, but the present invention is not limited thereto. A different number of user terminals may be configured to communicate with the information processing system 230 over the network 220.

In one embodiment, the information processing system 230 may receive data (e.g., a gate-level netlist, a plurality of libraries, signal switching information in the netlist, a target corner including target operating voltage (VDD_{targ}) and target temperature (T_{targ}), etc.) from the user terminals 210_1, 210_2, and 210_3 through an application or the like that runs in the user terminals 210_1, 210_2, and 210_3. Subsequently, the information processing system 230 may estimate switching power, internal power, leakage power, and the like at a target corner of an integrated circuit on the basis of the received data. Also, the information processing system 230 may predict power consumption at the target corner of the integrated circuit by using the estimated switching power, internal power, leakage power, and the like. In this way, the predicted power consumption at the target corner of the integrated circuit may be transmitted to the user terminals 210_1, 210_2, and 210_3.

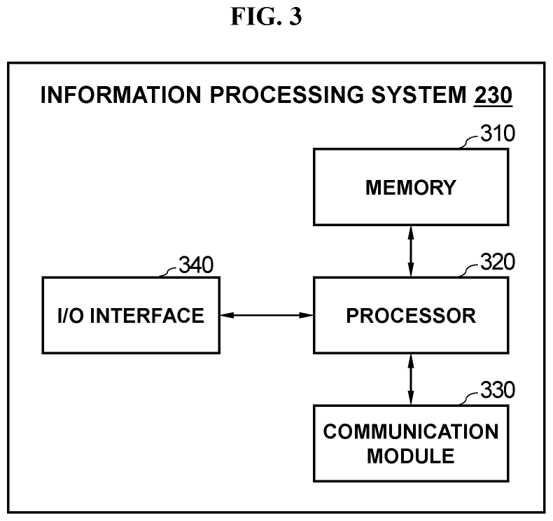

FIG. 3 is a block diagram showing the internal configuration of the information processing system 230 according to an embodiment of the present disclosure. The information processing system 230 may include a memory 310, a processor 320, a communication module 330, and an input/output interface 340. As shown in FIG. 3, the information processing system 230 may be configured to communicate information and/or data over a network using the communication module 330.

The memory 310 may include any non-transitory computer-readable recording medium. According to an embodiment, the memory 310 is a permanent mass storage device such as random access memory (RAM), read-only memory (ROM), disk drive, solid state drive (SSD), and flash memory. As another example, a permanent mass storage device such as ROM, SSD, flash memory, and disk drive may be included in the information processing system 230 as a separate permanent storage device distinct from the memory. Also, an operating system and at least one program code (e.g., code for predicting power consumption at a target corner of an integrated circuit installed and driven in the information processing system 230) may be stored in the memory 310.

These software components may be loaded from a computer-readable recording medium separate from the memory 310. The separate computer-readable recording medium may include a recording medium directly connectable to the information processing system 230 and may include, for example, a computer readable recording medium such as a floppy drive, a disk, a tape, a DVD/CD-ROM drive, and a memory card. As another example, software components may be loaded into the memory 310 through the communication module 330 rather than the computer-readable recording medium. For example, at least one program may be loaded into the memory 310 on the basis of a computer program (e.g., a power consumption prediction program including switching power, internal power, leakage power, etc. at the target corner of the integrated circuit) installed by files that are provided through the communication module 330 by a file distribution system that distributes an installation file of an application or by developers.

The processor 320 may be configured to process instructions of a computer program by performing basic arithmetic, logic, and input/output operations. The instructions may be provided to a user terminal (not shown) or other external systems by the memory 310 or the communication module 330. For example, the processor 320 may predict consumed power including switching power, internal power, leakage power, and the like at a target corner of an integrated circuit. In this case, the processor 320 may predict the power consumption of the integrated circuit by using a gate-level netlist of the integrated circuit, a plurality of libraries that define operations of cells included in the netlist, signal switching information in the netlist, and the like.

The communication module 330 may provide a configuration or function for a user terminal (not shown) and the information processing system 230 to communicate with each other over a network, and the information processing system 230 may provide a configuration or function for communicating with other systems (e.g., a separate cloud system). As an example, control signals, instructions, data, etc. which are provided under the control of the processor 320 of the information processing system 230 are transmitted to a user terminal through a communication module of a user terminal via the communication module 330 and a network. For example, the user terminal may receive the predicted switching power, internal power, leakage power, and power consumption of the integrated circuit from the information processing system 230.

In addition, the input/output interface 340 of the information processing system 230 may be a means for interfacing with an input/output device (not shown) that may be connected to or included in the information processing system 230. Although the input/output interface 340 is illustrated as an element configured separately from the processor 320 in FIG. 3, the present invention is not limited thereto, and the input/output interface 340 may be included in the processor 320.

The information processing system 230 may include more components than those shown in FIG. 3. However, there is no need to clearly show most of the conventional components.

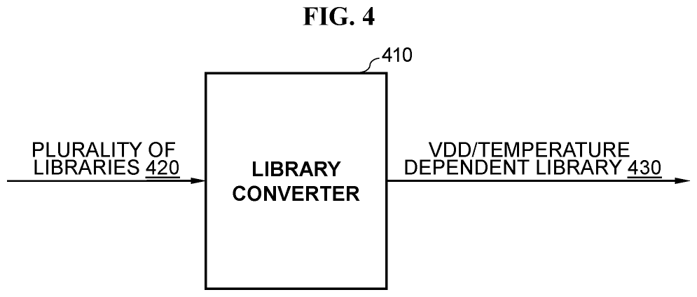

The processor 320 of the information processing system 230 may be configured to manage, process and/or store information and/or data received from a plurality of user terminals and/or a plurality of external systems. In an embodiment, the processor 320 may store, process, and transmit an integrated circuit, a netlist of an integrated circuit, libraries, signal switching information, a target corner, etc. which are received from a user terminal. For example, the processor 320 may estimate switching power, internal power, leakage power, etc. at a target corner on the basis of the received integrated circuit, netlist of the integrated circuit, libraries, signal switching information, target corner, etc., and may output the average power consumption, power waveforms, etc. of the corresponding integrated circuit on the basis of the estimated switching power, internal power, leakage power, etc. FIG. 4 is a diagram illustrating an example in which a library converter 410 generates a VDD/temperature dependent library 430 according to an embodiment of the present disclosure. As shown, the library converter 410 may generate the VDD/temperature dependent library 430 using a plurality of libraries 420. That is, the library converter 410 may generate a VDD/temperature dependent library 430 capable of predicting power consumption at an arbitrary target corner by using the plurality of libraries 420.

In an embodiment, the plurality of libraries 420 may include libraries at three or more different corners. For example, the plurality of libraries 420 may include a library for a first corner, a library for a second corner, a library for a third corner, etc. Here, the first corner may include a first corner operating voltage VDD₁ and a first corner temperature T₁, the second corner may include a second corner operating voltage VDD₂ and a second corner temperature T₂, and the third corner may include a third corner operating voltage VDD₃ and a third corner temperature T₃. Also, the second corner operating voltage VDD₂ and the third corner operating voltage VDD₃ may be different from each other, and the second corner temperature T₂ and the third corner temperature T₃ may be different from each other.

In the above example, the library converter 410 may generate a VDD/temperature dependent library 430 capable of predicting power consumption of an integrated circuit at an arbitrary target corner by using the first corner, the second corner, the third corner, etc., which are included in the plurality of libraries 420. In this case, a power consumption tool (e.g., 100 in FIG. 1) may receive a netlist, signal switching information, a target corner, etc. in addition to the VDD/temperature dependent library 430 and may estimate switch power, internal power, leakage power, etc. at a corresponding target corner. Subsequently, the average power consumption, power waveforms, etc. of the integrated circuit at the target corner may be output based on the switching power, the internal power, the leakage power, etc.

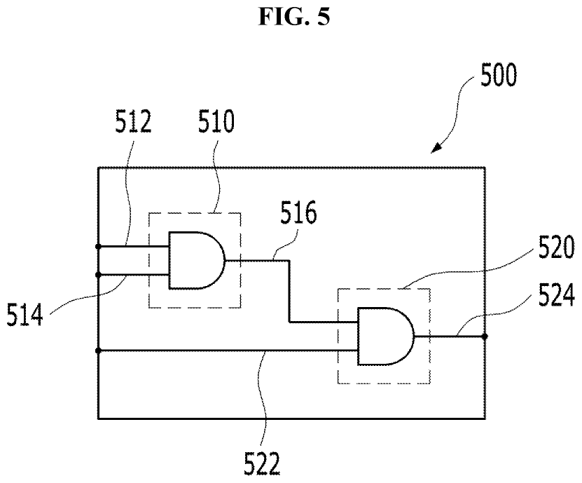

FIG. 5 is a diagram illustrating an example of a gate-level netlist 500 of an integrated circuit according to an embodiment of the present disclosure. As described above, the netlist 500 may correspond to a circuit configured to perform a logical operation on one or more binary input values to obtain a logical output value. As shown, the netlist 500 may be configured to include two cells 510 and 520 and wires 512, 514, 516, 522, and 524 connected to the cells. For example, the cells 510 and 520 may be AND gates, and the first cell 510 may be configured to receive an input value through the first wire 512 and the second wire 514 and output an output value through the third wire 516. Also, the second cell 520 may be configured to receive an input value through the third wire 516 and the fourth wire 522 and output an output value through the fifth wire 524.

The power consumption of the integrated circuit may be largely classified into leakage power and dynamic power, and the dynamic power may be classified into internal power and switching power. Here, the internal power may include short-circuit power and power consumed by charging or discharging a capacitor inside a cell.

In an embodiment, the switching power included in the power consumption of the integrated circuit may indicate power consumed when capacitances of all the wires 512, 514, 516, 522, and 524 in the netlist 500 are changed or discharged. That is, by summing power consumed while the capacitances of the first wire 512, the second wire 514, the third wire 516, the fourth wire 522, and the fifth wire 524 in the netlist 500 are charged and discharged, switching power may be calculated when the integrated circuit corresponding to the netlist 500 operates according to the signal switching information. In this case, the switching power at the target corner may be calculated to be independent of the target temperature T_{targ} and to be proportional to the square of the target operating voltage VDD_{targ}. For example, the switching power at the target corner may be calculated based on Equation 1.

$${\sum }_{i ∈ NET} {a}_{i} {C}_{i} {VDD}_{targ}^{2} \qquad [ Equation 1 ]$$

Here, NET may denote a set of all the wires 512, 514, 516, 522, and 524 in the netlist 500, aᵢ may denote switching activity of each wire, and Cᵢ may denote the capacitance of each wire. In this case, the switching activity of each wire may represent the number of times a value in the corresponding wire switches to 0 or 1 during simulation (i.e., while the integrated circuit is driven according to the signal switching information), and the capacitance of the wire may be a value determined by length, thickness, or the like of the wire.

Switching activity information only depends on the signal switching information, and the capacitance of the wire depends on VDD and temperature, but to a very small extent. Therefore, it can be assumed that the switching power is independent of temperature and is proportional to the square of VDD. Since switching power is not described in a library, a processor may calculate the switching power to be independent of temperature and proportional to the square of VDD. For example, for a design and scenario in which the switching power is 2 when VDD is 1.0, the switching power for the target VDD of 1.2 may be calculated as 2.88, which is 2×1.44.

In FIG. 5, the netlist 500 is illustrated as including two cells 510 and 520 and five wires 512, 514, 516, 522, and 524, but the present invention is not limited thereto. An arbitrary number of cells and an arbitrary number of wires may be included in the netlist. Also, although only AND gates are illustrated as being included in the netlist 500 in FIG. 5, various types of gates (cells) may be included. In this case, the switching power of the integrated circuit corresponding to the netlist may be calculated by summing power consumed while the capacitances of an arbitrary number of wires included in the netlist are charged and discharged.

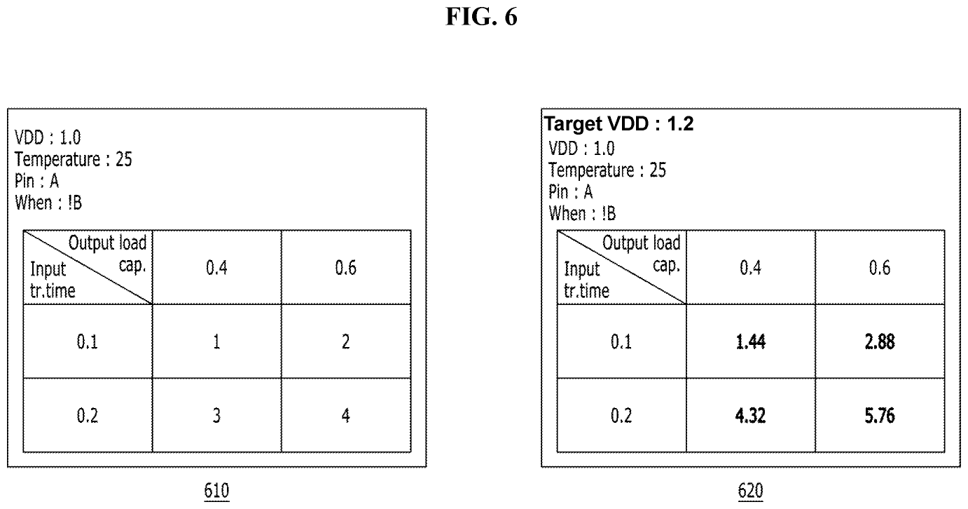

FIG. 6 is a diagram illustrating an example of calculating internal power data 620 at a target corner by using internal power data 610 at a first corner according to an embodiment of the present disclosure. In an embodiment, the internal power may represent the sum of short-circuit power and power consumed by charging and discharging capacitors inside cells in the netlist. The power consumed by charging and discharging capacitor in the cells included in the netlist has the same equation as the switching power, so the power consumption is independent of temperature and is proportional to the square of VDD. Also, the short-circuit power of each cell is proportional to Equation 2.

$$\frac{( 0.5 - {V}_{T} )}{{8}^{{V}_{T}^{3}}} {VDD}^{2} \qquad [ Equation 2 ]$$

Here, V_{T} may denote

$$\frac{{V}_{th}}{VDD} ,$$

and v_{ch} may denote a threshold voltage. As the technology becomes miniaturized, the proportion of the threshold voltage increases gradually, but the proportion is still small, and the value of V_{T} is close to zero. Thus, it is assumed that the short-circuit power is also proportional to the square of the operating voltage and independent of the temperature.

In an embodiment, the library for the first corner may include internal power data 610. That is, the internal power data 610 may include internal power at the first corner including the first corner operating voltage VDD₁ and the first corner temperature T₁. For example, when the first corner operating voltage is 1.0 V and the first corner temperature is 25° C., internal power data 610 corresponding to an input state of pin A when the input of pin B of a specific cell (e.g., an AND gate) is 0 may be displayed as a two-dimensional table. For example, the two-dimensional table shows information on internal power corresponding to an input transition time that represents a time interval at which the input of pin A is switched from 0 to 1 or from 1 to 0 and an output load cap that represents the capacitance of an output wire of a specific cell. In the illustrated example, when a delay time (i.e., a transition time) of the input value of pin A of the specific cell is 0.1 and the capacitance of the output wire is 0.4, the internal power may be calculated as 1. Also, when a delay time of the input value of pin A connected to the specific cell is 0.1 and the capacitance of the output wire of the corresponding cell is 0.6, the internal power may be calculated as 2.

In an embodiment, the internal power at the target corner may be calculated to be independent for the target temperature T_{targ} and to be proportional to

$${( \frac{{VDD}_{Targ}}{{VDD}_{1}} )}^{2} .$$

That is, the internal power at the target corner may be estimated as a value calculated by multiplying power values in the internal power data 610 included in the library for the first corner by

$${( \frac{{VDD}_{Targ}}{{VDD}_{1}} )}^{2} .$$

For example, when the first corner operating voltage VDD₁ is 1 and the target operating voltage VDD_{targ} is 1.2, the internal power data 620 at the target corner may be generated by multiplying each internal power by

$${( \frac{{VDD}_{Targ}}{{VDD}_{1}} )}^{2} = 1.44 .$$

In the shown example, when a delay time of the input value of pin A connected to the specific cell (e.g., an AND gate) is 0.1 and the capacitance of the output wire of the corresponding cell is 0.4, the internal power at the target corner may be calculated as 1.44. Also, when a delay time of the input value of pin A connected to the specific cell is 0.1 and the capacitance of the output wire of the corresponding cell is 0.6, the internal power at the target corner may be calculated as 2.88.

In FIG. 6, it is shown that pieces of internal power data 610 and 620 are present when the input signal of pin A is switched when the input of pin B is 0 among the inputs of a specific cell included in the netlist, but the present invention is not limited thereto. When the input of pin A is 0, internal power data when the input signal of pin B is switched may also be stored. Also, although the pieces of internal power data 610 and 620, which correspond to when Input tr. time is 0.1 and 0.2 and Output load cap is 0.4 and 0.6, respectively, are shown in FIG. 6, the present invention is not limited thereto. There may be internal power data corresponding to any Input tr. time and Output load cap. With this configuration, it is possible to simply estimate internal power data at a target corner by using corner operating voltage and internal power data at a specific corner included in a library.

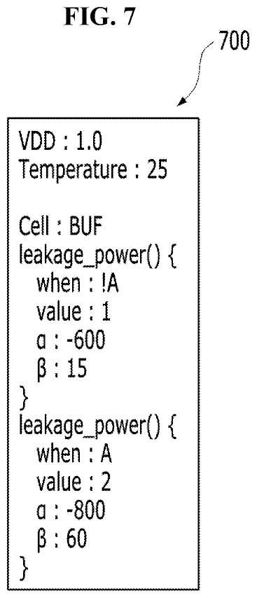

FIG. 7 is a diagram illustrating an example of a VDD/temperature dependent library 700 for calculating leakage power at a target corner according to an embodiment of the present disclosure. The leakage power is largely composed of sub-threshold leakage and gate-tunneling leakage. Since the proportion of sub-threshold leakage is large, it is assumed below that sub-threshold leakage is all of the leakage power.

In an embodiment, the leakage power at the target corner may be calculated based on the VDD/temperature dependent library 700 generated using libraries at three or more specific corners. For example, leakage power at a target corner may be estimated based on leakage power data included in the library for the first corner among the plurality of libraries, leakage power data included in the library for the second corner, leakage power data included in the library for the third corner, the signal switching information, the target operating voltage VDD_{targ}, and the target temperature T_{targ}. In this case, the first corner may include a first corner operating voltage VDD₁ and a first corner temperature T₁, the second corner may include a second corner operating voltage VDD₂ and a second corner temperature T₂, and the third corner may include a third corner operating voltage VDD₃ and a third corner temperature T₃. Also, the second corner operating voltage VDD₂ and the third corner operating voltage VDD₃ may be different from each other, and the second corner temperature T₂ and the third corner temperature T₃ may be different from each other. Also, the first corner may be different from the second corner, and the first corner may be different from the third corner.

Specifically, the leakage power of each cell included in the netlist at the target corner may be calculated by Equation 3.

$$P ( {VDD}_{1} , {T}_{1} ) \times {T}_{targ}^{2} \times exp ( \frac{α \times {VDD}_{targ} + β}{{T}_{targ}} ) \times \frac{{VDD}_{targ}}{{VDD}_{1}} \qquad [ Equation 3 ]$$

Here, α and β are values obtained for each input state of each cell in a library, and P(VDD,T) is a value described in the library regardless of signal switching information. A method proposed by the present disclosure obtains leakage power at the target operating voltage VDD_{targ} and the target temperature T_{targ} through the following operations.

1) Using Equation 4 below, α and β are obtained for each input state of each cell and described in a library.

2) Using Equation 3, leakage power values are changed for each input state of each cell in the library using the target operating voltage VDD_{targ}, the target T_{targ}, and α and β.

3) The leakage power of the entire circuit is calculated using the signal switching information and the changed leakage power values.

In Equation 3, P(VDD₁,T₁) may denote the leakage power at the first corner determined based on leakage power data included in the library for the first corner. That is, when Equation 3 is used, the leakage power at the target corner may be calculated based on the leakage power data and variables α and β of each cell at a specific corner.

In this case, α and β for each input state of each cell may be determined by Equation 4 (a system of two first order equations) generated by modifying Equation 3.

$$α \times {VDD}_{2} + β = {T}_{2} \times ln ( \frac{P ( {VDD}_{2} , {T}_{2} ) \times {VDD}_{1} )}{P ( {VDD}_{1} , {T}_{1} ) \times {T}_{2}^{2} \times {VDD}_{2} )} ) \\ α \times {VDD}_{3} + β = {T}_{3} \times ln ( \frac{P ( {VDD}_{3} , {T}_{3} ) \times {VDD}_{1} )}{P ( {VDD}_{1} , {T}_{1} ) \times {T}_{3}^{2} \times {VDD}_{3} )} ) \qquad [ Equation 4 ]$$

Here, P(VDD₂,T₂) may denote the leakage power at the second corner determined by leakage power data included in the library for the second corner, and P(VDD₃,T₃) may denote the leakage power at the third corner determined by leakage power data included in the library for the third corner. As described above, the second corner operating voltage VDD₂ and the third corner operating voltage VDD₃ may be different from each other, and the second corner temperature T₂ and the third corner temperature T₃ may be different from each other. Thus, variables α and β may be determined by Equation 4.

In an embodiment, the VDD/temperature dependent library 700 may include leakage power and variables α and β corresponding to an input state. For example, the VDD/temperature dependent library 700 may be a corner at which VDD and temperature are 1.0 and 25, respectively, and may include α (−600), β (15) and leakage power (1) when the input value of pin A of cell BUF (a buffer cell for delivering an input itself as an output without performing a special logical operation) is 0, and α (−800), β (60) and leakage power (2) when the input value of pin A is 1, etc.

In an embodiment, the leakage power at the target corner may be calculated based on the generated VDD/temperature dependent library 700. For example, when the target operating voltage VDD_{targ} is 1.2 and the target temperature T_{targ} is 125, the leakage power when the input of pin A of cell BUF is 1 may be calculated as

$$\approx 2 \cdot {125}^{2} \cdot exp ( \frac{- 800 \cdot 1.2 + 60}{1.25} ) \cdot \frac{1.2}{1} \approx 28$$

using Equation 3.

In FIG. 7, the VDD/temperature dependent library 700 is illustrated as being used to estimate leakage power for cell BUF included in the netlist, but the present invention is not limited thereto. The VDD/temperature dependent library 700 may include data about each cell such as AND, OR, NAND, NOR, NOT, XOR, and XNOR included in the netlist. With this configuration, it is possible to simply estimate leakage power at a target corner by using the VDD/temperature dependent library 700 generated based on libraries at three or more corners.

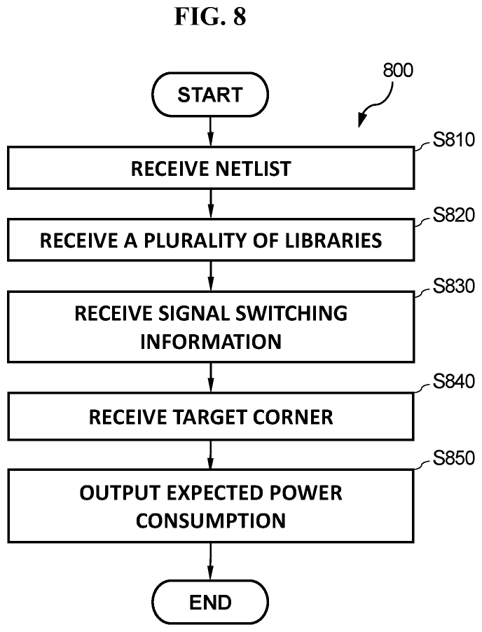

FIG. 8 is a flowchart illustrating a method 800 of predicting power consumption of an integrated circuit at a target corner according to an embodiment of the present disclosure. The method 800 of predicting power consumption of an integrated circuit may be performed by an information processing system (e.g., at least one processor of an information processing system). In an embodiment, the method 800 of predicting power consumption of an integrated circuit may be initiated by a processor receiving a netlist (S810). For example, the netlist may correspond to a gate-level netlist of the integrated circuit.

The processor may receive a plurality of libraries defining the operation of at least one cell included in the netlist (S820). Also, the processor may receive signal switching information in the netlist (S830). The plurality of libraries may include a library for a first corner, a library for a second corner, a library for a third corner, etc. Here, the library for each corner may include internal power data, leakage power data, and the like at the corresponding corner.

The processor may receive a target corner including a target operating voltage VDD_{targ} and a target temperature T_{targ} (S840). When the target corner is received, the processor may output expected power consumption of the integrated circuit at the target corner (S850). In an embodiment, the processor may output the average power consumption or power waveforms of the integrated circuit at the target corner.

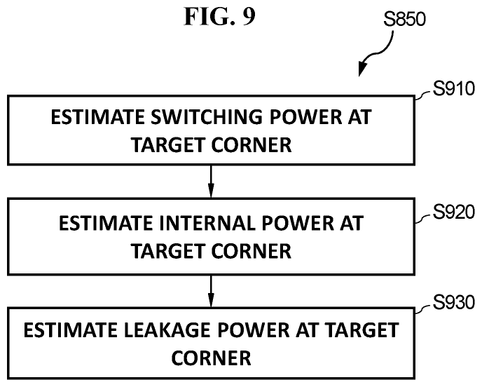

FIG. 9 is a flowchart illustrating a method S850 of outputting expected power consumption of an integrated circuit at a target corner according to an embodiment of the present disclosure. The method S850 of outputting expected power consumption of the integrated circuit may be performed by an information processing system (e.g., at least one processor of an information processing system). In an embodiment, the method 850 of outputting expected power consumption of the integrated circuit may be initiated by a processor estimating switching power at the target corner (S910). The processor may estimate the switching power at the target corner of the integrated circuit on the basis of a received netlist, signal switching information, and target operating voltage VDD_{targ}. Here, the switching power represents power consumed while the capacitances of all wires in the netlist are charged and discharged and the switching power at the target corner may be calculated to be independent of the target temperature T_{targ} and to be proportional to the square of the target operating voltage VDD_{targ}.

The processor may estimate internal power at the target corner (S920). The processor may estimate the internal power at the target corner of the integrated circuit on the basis of internal power data included in the library for the first corner among the plurality of libraries, the signal switching information, and the target operating voltage VDD_{targ}. Here, the internal power represents the sum of short-circuit power and power consumed by charging and discharging capacitors inside cells included in the netlist, and the internal power at the target corner may be computed to be independent of the target temperature (T_{targ}) and to be proportional to

$${( \frac{{VDD}_{Targ}}{{VDD}_{1}} )}^{2} .$$

The processor may estimate leakage power at the target corner (S930). In an embodiment, the processor may estimate leakage power at the target corner of the integrated circuit on the basis of leakage power data included in the library for the first corner among the plurality of libraries, leakage power data included in the library for the second corner, leakage power data included in the library for the third corner, the signal switching information, the target operating voltage VDD_{targ}, and the target temperature T_{targ}. Subsequently, the processor may output the average power consumption or power waveforms of the integrated circuit on the basis of the estimated switching power, internal power, and leakage power at the target corner.

FIG. 9 illustrates that the processor sequentially estimates switching power, internal power, and leakage power, but the present invention is not limited thereto. For example, the processor may estimate switching power, internal power, and leakage power in an arbitrary order. For example, the processor may estimate switching power, internal power, and leakage power at the same time.

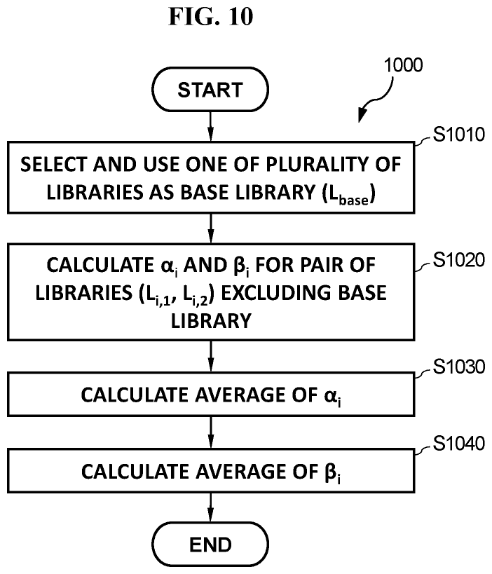

FIG. 10 is a flowchart illustrating a method 1000 of generating a VDD/temperature dependent library according to an embodiment of the present disclosure. The method 1000 of generating a VDD/temperature dependent library may be performed by an information processing system (e.g., at least one processor of an information processing system). The method 1000 of generating a

VDD/temperature dependent library may be initiated by a processor receiving a plurality of libraries. In this case, the plurality of libraries may include libraries for three or more specific corners.

The processor may select one library from among a plurality of received libraries and use the selected library as a base library L_{base} (S1010). Subsequently, the processor may calculate αᵢ and βᵢ for a pair of libraries (L_{i,1}, L_{i,2}) excluding the base library L_{base} (S1020). Here, since one value for leakage power is described for each input state of each cell in a library, αᵢ and βᵢ may have values varying depending on the input state of the corresponding cell. In order to calculate αᵢ and βᵢ, leakage power data included in the base library L_{base} and the pair of libraries (L_{i,1}, L_{i,2}) may be used for each input state of each cell. For example, the processor may calculate αᵢ and βᵢ using the leakage power data of the libraries and the above Equation 3 and Equation 4.

In an embodiment, the processor may calculate the average of αᵢ (S1030). Also, the processor may calculate the average of βᵢ (S1040). For example, the processor may calculate α₁ and β₁ from one pair of libraries (L_{i,1}, L_{i,2}) and calculate α₂ and β₂ from another pair of libraries (L_{2,1}, L_{2,2}). Subsequently, the processor may calculate the final value a using the average of α₁ and α₂ and may calculate the final value β using the average of β₁ and β₂. The processor may generate a VDD/temperature dependent library for estimating leakage power at the target corner using the calculated final value a and final value β.

The above-described method may be provided as a computer program stored in a computer-readable recording medium for execution by a computer. The medium may store computer-executable programs permanently or temporarily for execution or download. Also, the medium may be various recording means or storage means in the form of a single hardware element or a combination of several hardware elements. The medium is not limited to a medium directly connected to any computer system and may be distributed over a network. Examples of the medium include media configured to store program instructions by including magnetic media such as a hard disk, a floppy disk, and a magnetic tape, optical media such as a compact disc-read only memory (CD-ROM) and a digital versatile disc (DVD), magneto-optical media such as a floptical disk, a ROM, a random access memory (RAM), and a flash memory. Also, other examples of the medium may include recording media or storage media managed by app stores that distribute applications, sites that supply or distribute various other software, and servers.

The methods, operations, or techniques of the present disclosure may be implemented by various means. For example, the techniques may be implemented in hardware, firmware, software, or a combination thereof. Those skilled in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, the various illustrative components, blocks, modules, circuits, and steps have been described above generally in terms of their functionality. Whether such functionality is implemented as hardware or software depends upon the particular application and design constraints imposed on the overall system. Those skilled in the art may implement the described functionality in varying ways for each particular application, but such implementation decisions should not be interpreted as causing a departure from the scope of the present disclosure.

For a hardware implementation, the processing units used to perform the techniques may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, a computer, or a combination thereof.

Thus, the various illustrative logical blocks, modules, and circuits described in connection with the disclosure herein may be implemented or performed with a general-purpose processor, a DSP, an ASIC, a FPGA or other programmable logic device, discrete gate or transistor logic, discrete hardware components, or any combination thereof designed to perform the functions described herein. A general-purpose processor may be a microprocessor, but as an alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

For firmware and/or software implementations, the techniques may be embodied as instructions stored on a computer-readable medium, such as random access memory (RAM), read-only memory (ROM), non-volatile random access memory (NVRAM), programmable read-only memory (PROM), electrically erasable PROM (EEPROM), flash memory, compact disc (CD), magnetic or optical data storage device, etc. The instructions may be executable by one or more processors and may cause the processor(s) to perform certain aspects of the functionality described herein.

Although the above-described embodiments refer to utilizing aspects of the presently disclosed subject matter in one or more stand-alone computer systems, the present disclosure is not limited thereto but rather may be implemented in connection with any computing environment, such as a network or distributed computing environment. Still further, aspects of the subject matter of the present disclosure may be implemented in a plurality of processing chips or devices, and storage may similarly be affected across a plurality of devices. Such devices may include PCs, network servers, and handheld devices.

In various embodiments of the present disclosure, even when a plurality of libraries do not include a library for a target corner, it is possible for a power consumption estimation tool to effectively estimate or predict switching power, internal power, leakage power, and power consumption of an integrated circuit at a target corner with high accuracy.

In various embodiments of the present disclosure, it is possible to simply estimate internal power data at a target corner by using a corner operating voltage and internal power data at a specific corner included in a library.

In various embodiments of the present disclosure, it is possible to simply estimate leakage power at a target corner using a VDD/temperature dependent library generated based on libraries at three or more corners.

Advantageous effects of the present disclosure are not limited to the aforementioned effects, and other advantageous effects that are not described herein should be clearly understood by those having ordinary skill in the technical field to which the present invention pertains (hereinafter referred to as “those skilled in the art”).

Although the present disclosure has been described herein in connection with some embodiments, various changes and modifications may be made therein without departing from the scope of the present disclosure that can be understood by those skilled in the art. Also, these changes and modifications should be regarded as falling within the scope of the claims appended thereto.

What is claimed is:

1. A method of predicting power consumption of an integrated circuit, which is performed by at least one processor, the method comprising:
receiving a gate-level netlist of the integrated circuit;
receiving a plurality of libraries defining operation of at least one cell included in the netlist;
receiving signal switching information in the netlist;
receiving a target corner including a target operating voltage (VDD_{targ}) and a target temperature (T_{targ}); and
estimating switching power at the target corner of the integrated circuit on the basis of the netlist, the signal switching information, and the target operating voltage (VDD_{targ}).

2. The method of claim 1, further comprising estimating internal power at the target corner of the integrated circuit on the basis of internal power data included in a library for a first corner among the plurality of libraries, the signal switching information, and the target operating voltage (VDD_{targ}).

3. The method of claim 2, further comprising estimating the leakage power at the target corner of the integrated circuit on the basis of leakage power data included in the library for the first corner among the plurality of libraries, leakage power data included in a library for a second corner, leakage power data included in a library for a third corner, the signal switching information, the target operating voltage (VDD_{targ}), and the target temperature (T_{targ}),
wherein
the first corner comprises a first corner operating voltage (VDD₁) and a first corner temperature (T₁),
the second corner comprises a second corner operating voltage (VDD₂) and a second corner temperature (T₂),
the third corner comprises a third corner operating voltage (VDD₃) and a third corner temperature (T₃),
the second corner operating voltage (VDD₂) and the third corner operating voltage (VDD₃) are different from each other,
the second corner temperature (T₂) and the third corner temperature (T₃) are different from each other,
the first corner and the second corner are different from each other, and
the first corner and the third corner are different from each other.

4. The method of claim 3, further comprising outputting average power consumption or power waves of the integrated circuit on the basis of the estimated switching power, internal power, and leakage power at the target corner.

5. The method of claim 3, wherein the leakage power of each cell included in the netlist at the target corner is calculated as
$$P ( {VDD}_{1} , {T}_{1} ) \times {T}_{targ}^{2} \times exp ( \frac{α \times {VDD}_{targ} + β}{{T}_{targ}} ) \times \frac{{VDD}_{targ}}{{VDD}_{1}} ,$$
where
P(VDD₁,T₁) depicts leakage power at the first corner determined based on leakage power data included in the library for the first corner,
α and β are determined by a system of two first order equations:
$$α \times {VDD}_{2} + β = {T}_{2} \times ln ( \frac{P ( {VDD}_{2} , {T}_{2} ) \times {VDD}_{1} )}{P ( {VDD}_{1} , {T}_{1} ) \times {T}_{2}^{2} \times {VDD}_{2} )} ) and$$
$$α \times {VDD}_{3} + β = {T}_{3} \times ln ( \frac{P ( {VDD}_{3} , {T}_{3} ) \times {VDD}_{1} )}{P ( {VDD}_{1} , {T}_{1} ) \times {T}_{3}^{2} \times {VDD}_{3} )} )$$
for each state of each cell included in the netlist,
P(VDD₂,T₂) depicts leakage power at the second corner determined by leakage power data included in the library for the second corner,
P(VDD₃,T₃) depicts leakage power at the third corner determined by leakage power data included in the library for the third corner, and
the leakage power at the target corner is calculated based on the signal switching information, α and β of each cell included in the netlist, the target temperature (T_{targ}), and the target operating voltage (VDD_{targ}).

6. The method of claim 2, wherein
the first corner comprises a first corner operating voltage (VDD₁) and a first corner temperature (T₁),
the internal power represents the sum of the short-circuit power and power consumed by charging and discharging capacitors inside cells included in the netlist, and
the internal power at the target corner is computed to be independent of the target temperature (T_{targ}) and to be proportional to
$${( \frac{{VDD}_{Targ}}{{VDD}_{1}} )}^{2} .$$

7. The method of claim 2, wherein the first corner comprises a first corner operating voltage (VDD₁) and a first corner temperature (T₁), and the estimating of internal power at the target corner of the integrated circuit on the basis of internal power included in a library for a first corner among the plurality of libraries, the signal switching information, and the target operating voltage (VDD_{targ}) comprises multiplying power values in internal power data included in the library for the first corner by
$${( \frac{{VDD}_{Targ}}{{VDD}_{1}} )}^{2} .$$

8. The method of claim 1, wherein
the switching power represents power consumed while capacitances of all wires in the netlist are charged and discharged, and
the switching power at the target corner is calculated to be independent of the target temperature (T_{targ}) and to be proportional to the square of the target operating voltage (VDD_{targ}).

9. The method of claim 1, wherein the switching power at the target corner is calculated as Σ_{i∈NET}aᵢCᵢVDD_{targ}²,
where NET depicts a set of all wires in the netlist, aᵢ depicts a wire switching activity, and Cᵢ depicts a wire capacitance.

10. A non-transitory computer-readable storage medium storing instructions that, when executed by a processor, cause the processor to perform the method of claim 1.

11. An apparatus comprising:
a memory; and
at least one processor connected to the memory and configured to execute at least one computer-readable program included in the memory,
wherein
the at least one program comprises instructions configured to:
receive a gate-level netlist of an integrated circuit;
receive a plurality of libraries defining operation of at least one cell included in the netlist;
receive signal switching information for the netlist;
receive a target corner including a target operating voltage (VDD_{targ}) and a target temperature (T_{targ},); and
estimate switching power at the target corner of the integrated circuit on the basis of the netlist, the signal switching information, and the target operating voltage (VDD_{targ}).
